(19) United States
(12) Patent Application Publication
(10) Pub. No.: US 2024/0116788 A1
(43) Pub. Date: Apr. 11, 2024

(54) SURFACE WATER SULFIDE REDUCTION

(71) Applicant: Clearwater BioLogic LLC, Babbitt, MN (US)

(72) Inventors: Jeffrey John Hanson, Babbitt, MN (US); William Newman, Brooklyn Center, MN (US)

(21) Appl. No.: 18/482,899

(22) Filed: Oct. 8, 2023

Related U.S. Application Data
(60) Provisional application No. 63/414,251, filed on Oct. 7, 2022.

(51) Int. Cl. C02F 1/70; C02F 1/28

(52) U.S. Cl. CPC C02F 1/705; C02F 1/281; C02F 2103/007

(57) ABSTRACT

The present disclosure relates to apparatuses, systems, and methods for removing hydrogen sulfide from surface water. One apparatus includes a vessel having an inlet, an outlet, and a closure, and a plurality of direct reduced iron (DRI) pellets contained within the vessel.

### FIELD OF DISCLOSURE

The present disclosure relates generally to a system for the reduction of hydrogen sulfide from surface waters.

### BACKGROUND

Hydrogen sulfide may exist in surface waters (e.g., lakes, rivers, streams, etc.). In some cases, hydrogen sulfide may be produced by the conversion of sulfate (SO₄) into hydrogen sulfide as either H₂S or HS— depending on the pH. This process may be carried out by a bioreactor, such as that described in U.S. Pat. Nos. 10,597,318, and/or 11,104,596, the entireties of which are incorporated herein by reference.

Some previous approaches to reducing hydrogen sulfide from surface waters add unwanted chemicals. Some previous approaches are not economically or technically viable.

### BRIEF DESCRIPTION OF THE DRAWINGS

FIG. 1 illustrates an apparatus for hydrogen sulfide reduction in accordance with one or more embodiments of the present disclosure.

FIG. 2 illustrates a system for hydrogen sulfide reduction in accordance with one or more embodiments of the present disclosure.

### DESCRIPTION OF THE PREFERRED EMBODIMENTS

The following description illustrates the manner in which the principles of this disclosure are applied, but is not to be construed as in any sense limiting the scope of the disclosure.

An example system in accordance with the present disclosure includes Direct Reduced Iron (DRI). DRI is a specific type of a class of products that are referred to generally as “sponge iron.” DRI is a premium ore-based metallic (OBM) raw material made by removing chemically-bound oxygen from iron ore (e.g., iron oxide pellets and/or lump ores). DRI can be produced in powder, pellet, lump and/or briquette form. Where the term “DRI pellets” appears herein, such usage is intended to refer to a particular type of DRI known as “cold DRI (CDRI) pellets.” CDRI pellets are generally spherical in shape but not uniform in shape or size. Generally speaking, the pellets are on the order of 1 cm in average diameter, with a range encompassing 4 millimeters to 20 millimeters.

DRI pellets, as known to those of skill in the art, can be formed from iron oxide pellets and/or lump ores (e.g., hematite) without melting. A reactive process can be carried out on these pellets and/or lump ores to remove oxygen therefrom. The resultant DRI pellets contain high iron content and are conductive to electricity. In some cases, DRI pellets are at least 90% iron (e.g., total iron). In some cases, DRI pellets are between 90% and 94% iron. In some cases, DRI pellets are in excess of 95% iron (and up to 97% iron). In contrast, taconite pellets contain approximately 67% iron content and are not electrically conductive.

In addition to iron, DRI pellets typically contain other elements and/or compounds in small proportions including, for instance, carbon (e.g., 1.0 to 4.0%), phosphorus (e.g., 0.005% to 0.09%), Sulfur (e.g., 0.001% to 0.03%), gangue, (e.g., 2.8% to 6%), and trace amounts of manganese, copper, nickel, chromium, molybdenum, tin, lead, and/or zinc. DRI pellets exhibit a bulk density of 1,600 to 1,900 kilograms per cubic meter and an apparent density of 3.4 to 3.6 grams per cubic centimeter.

After reduction in a shaft furnace, DRI pellets are cooled to approximately 50 degrees Celsius where they can be used in a nearby electric arc furnace (EAF). The production of DRI pellets is becoming increasingly common in the iron and steel industries because DRI pellets can be used in EAFs for the production of steel. In contrast to a conventional blast furnace, an EAF heats material using an electric arc. EAFs have well-documented advantages ranging from flexibility and space savings to reduced emissions and lower costs.

The removal of oxygen, discussed above, leaves voids that render DRI pellets porous with an open cell structure compared to iron ore. Embodiments of the present disclosure take advantage of this porosity and increased surface area to remove hydrogen sulfide from water. Hydrogen sulfide may impart a characteristic “rotten egg” taste or smell in water and can have harmful effects to aquatic environments, so its removal is desirable.

In some embodiments, for example, DRI pellets are placed in the effluent stream from sulfate-reducing, floating bioreactors, though the present disclosure is not so limited. DRI pellets can be placed in a vessel such as a bed, for instance, which may be vertical or horizontal in orientation. Water that contains elevated levels of hydrogen sulfide (as either H₂S or HS—) can be passed through the bed of DRI pellets. The water can pass into the voids of the DRI pellets wherein the iron reacts with the hydrogen sulfide to form iron sulfide (FeS). Hydrogen sulfide may be retained through adsorption onto the DRI pellets. It is noted that test results using embodiments in accordance with the present disclosure have repeatedly proven effective hydrogen sulfide removal as shown below:

TABLE 1

| | Test 1 | | Test 2 | |
|---|---|---|---|---|
| Initial sulfate (SO₄) concentration | 328 | mg/L | 337 | mg/L |
| Biologically generated Hydrogen sulfide | 77 | mg/L | 96 | mg/L |
| Effluent sulfate concentration | 0.0 | mg/L | 0.0 | mg/L |
| Effluent hydrogen sulfide concentration | 0.3 | mg/L | 0.4 | mg/L |

The resultant iron sulfide is valuable and may be used in other remediation processes. Additionally, the hydrogen produced may be captured and used in the reductive process to make DRI itself, or in other contexts, such as fuel for internal combustion engines.

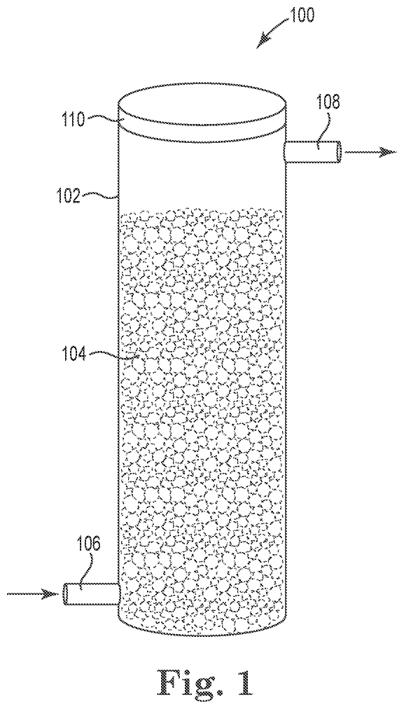

FIG. 1 illustrates an apparatus 100 for hydrogen sulfide reduction in accordance with one or more embodiments of the present disclosure. The apparatus 100 is an example vertical configuration, though it is noted that embodiments of the present disclosure are not so limited. The apparatus 100 includes a vessel 102 having an inlet 106 located on a first (e.g., bottom) portion of the vessel 102 and an outlet 108 located on a second (e.g., top) portion of the vessel 102. The first and second portions may be on opposing ends of the vessel 102 (e.g., top and bottom, front and back, left and right, etc.). The vertical configuration of the example apparatus 100 is an “upflow” column, though one or ordinary skill in the art will understand that the inlet 106 located on the top portion and the outlet 108 located on the bottom portion results in a “downflow” column. The vessel 102 can be made of any suitable material including glass, polymers, such as polyvinyl chloride (PVC), and/or other materials.

As shown in FIG. 1, the vessel 102 can be filled (e.g., partially filled) with DRI pellets 104. The example illustrated in FIG. 1 includes a threaded cap 110 that can be removed for the addition and/or removal of the DRI pellets 104, removal of hydrogen sulfide, or for other purposes (e.g., cleaning, maintenance, etc.). It is noted that embodiments herein are not so limited; other closures suitable for the vessel 102 can be used including caps, covers, lids, plugs, etc. In some embodiments, the vessel 102, when closed, is liquid tight.

The apparatus 100 can be placed in the effluent stream from sulfate-reducing floating bioreactors. That is, in some embodiments, the inlet 106 is connected to, and in fluid communication with, an outlet of a sulfate-reducing floating bioreactor. In operation, water can pass through the inlet 106, through the bed of DRI pellets 104, and out through the outlet 108. In some embodiments, the water is allowed to passively flow through the apparatus 100. In some embodiments, the water may be forced to flow through the apparatus 100 using a pump (not illustrated in FIG. 1), for example. Hydrogen sulfide (as either H₂S or HS—) in the water can react with the DRI pellets 104 to form iron sulfide (FeS). Hydrogen sulfide may be retained through adsorption onto the DRI pellets 104.

The particular orientation, dimensions, and/or shape of the apparatus 100 illustrated in FIG. 1 is not to be taken in a limiting sense. For example, some embodiments utilize a horizontal, rather than a vertical configuration (such as the column shown in FIG. 1). Some embodiments use a cylindrical vessel while other embodiments utilize different shapes. The inlet 106 and/or outlet 108 can be sized and placed to accommodate a desired flow through the apparatus 100.

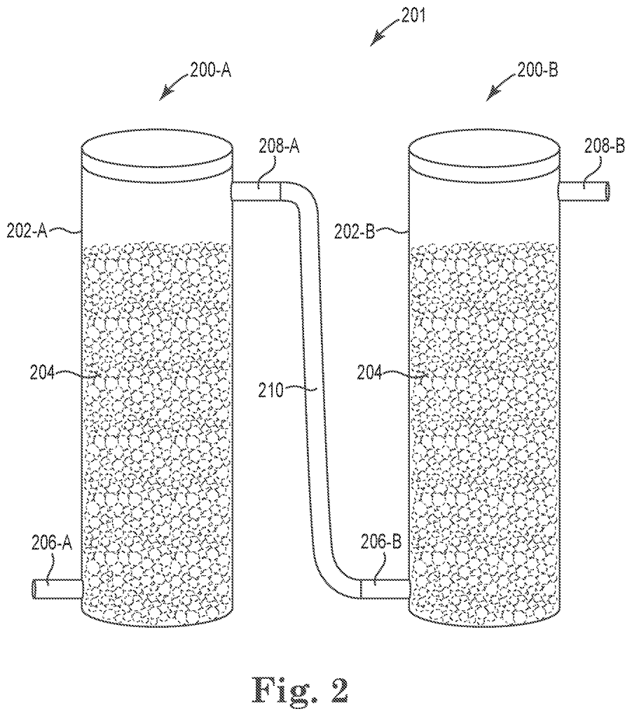

FIG. 2 illustrates a system 201 for hydrogen sulfide reduction in accordance with one or more embodiments of the present disclosure. As shown in FIG. 2, the system 201 can include two apparatuses 200-A and 200-B, though embodiments herein do not limit systems to a particular quantity of apparatuses. In operation, water can pass through the inlet 206-A, through the bed of DRI pellets 104 in the first apparatus 200-A, out of the first apparatus 200-A via the outlet 208-A, through a conduit (e.g., pipe, tube, etc.) 210, into the inlet 206-B, through the bed of DRI pellets 104 in the second apparatus 200-B, and out of the second apparatus 200-B via the outlet 208-B.

Most of the hydrogen sulfide is removed from the water by the DRI pellets 204 in the first apparatus 200-A. The second vessel can serve as a “backup” or a “polishing” apparatus that removes remaining trace amounts of hydrogen sulfide. Accordingly, the first apparatus 200-A is likely to become saturated before the second apparatus 200-B. Embodiments herein can determine that the first apparatus 200-A has become saturated based upon data from one or more detectors configured to detect amounts and/or concentrations of hydrogen sulfide in water. For example, a detector can be placed at, or upstream of, the inlet 206-A, downstream of the outlet 208-A, and/or downstream of the outlet 208-B. If the detected concentration of hydrogen sulfide in the water exceeds a threshold, embodiments herein can determine that the first apparatus 200-A has become saturated. In one example, a first detector associated with the inlet 206-A detects hydrogen sulfide entering the system 201 at a concentration of 100 mg/L. If a second detector associated with the outlet 208-B detects hydrogen sulfide exiting the system 201 at a concentration exceeding a threshold (e.g., 50-70 mg/L), a notification may be provided (e.g., via a computing device). Exceeding the threshold can include the second detector detecting a concentration of hydrogen sulfide that exceeds a threshold proportion to a concentration of hydrogen sulfide detected by the first detector.

Upon saturation of the first apparatus 200-A, the first apparatus 200-A can be removed from the system 201. The second apparatus 200-B can be swapped in to replace the apparatus 200-A as the primary apparatus of the system 201 and a different apparatus can be inserted into the system 201 to serve as the “backup” or “polishing” apparatus. This swapping of the components of the system 201 allows reliable performance and avoids the need to shut down the system 201. In some embodiments, rather than removing and repositioning the apparatuses 200 themselves, the contents of the vessel 202-A can be removed. In some cases, the contents of the vessel 202-B can be moved to the vessel 202-A. In other cases, the contents of the vessel 202-B can be left in the vessel 202-B while fresh DRI pellets 204 are added to the vessel 202-A.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for removing hydrogen sulfide from surface water, comprising:
a vessel having an inlet, an outlet, and a closure; and
a plurality of direct reduced iron (DRI) pellets contained within the vessel.

2. The apparatus of claim 1, wherein the plurality of DRI pellets are comprised of at least 90 percent iron by weight.

3. The apparatus of claim 1, wherein the plurality of DRI pellets are comprised of at least 94 percent iron by weight.

4. The apparatus of claim 1, wherein each of the plurality of DRI pellets has a surface area exceeding 0.32 square meters per gram.

5. The apparatus of claim 1, wherein the DRI pellets are formed from a reduction of iron oxide pellets.

6. The apparatus of claim 1, wherein the inlet and the outlet are located on opposing portions of the apparatus.

7. The apparatus of claim 1, wherein the apparatus is configured to:
receive water containing hydrogen sulfide via the inlet;
adsorb the hydrogen sulfide onto the plurality of DRI pellets;
form iron sulfide via a reaction between the hydrogen sulfide and the DRI pellets; and
expel water via the outlet.

8. The apparatus of claim 1, wherein the vessel has a cylindrical shape.

9. A system for removing hydrogen sulfide from surface water, comprising:
a first vessel containing direct reduced iron (DRI) pellets, wherein the first vessel includes a first inlet and a first outlet; and
a second vessel containing DRI pellets, wherein the second vessel includes a second outlet and a second inlet that is connected to the first outlet.

10. The system of claim 9, further comprising:
a first detector configured to detect a first concentration of hydrogen sulfide in water at the first inlet; and
a second detector configured to detect a second concentration of hydrogen sulfide in water at the second outlet.

11. The system of claim 10, further comprising a computing device configured to provide a notification responsive to a determination that the second concentration exceeds a threshold proportion to the first concentration.

12. A method for removing hydrogen sulfide from surface water, comprising:
receiving water containing hydrogen sulfide via an inlet of a first vessel;
adsorbing a first portion of the hydrogen sulfide onto direct reduced iron (DRI) pellets contained in the first vessel and forming iron sulfide in the first vessel;
expelling the water from the first vessel into a second vessel; and
adsorbing a second portion of the hydrogen sulfide onto DRI pellets contained in the second vessel and forming iron sulfide in the second vessel.

13. The method of claim 12, wherein the method includes receiving the water containing hydrogen sulfide from an outlet of a sulfate-reducing floating bioreactor.

14. The method of claim 12, wherein the method includes producing an effluent hydrogen sulfide concentration less than 0.4 mg/L.

15. The method of claim 12, wherein the first portion of the hydrogen sulfide exceeds the second portion of the hydrogen sulfide.

16. The method of claim 12, wherein the method includes removing the first vessel responsive to determining that the DRI pellets contained in the first vessel are saturated with iron sulfide.

17. The method of claim 16, wherein the method includes replacing the first vessel with the second vessel and adding a third vessel containing DRI pellets such that an outlet of the second vessel is connected to an inlet of the third vessel.

18. The method of claim 12, wherein the method includes removing the DRI pellets from the first vessel responsive to determining that the DRI pellets contained in the first vessel are saturated with iron sulfide.

19. The method of claim 12, wherein the method includes capturing hydrogen gas emitted from the first vessel.

20. The method of claim 19, wherein the method includes using the hydrogen gas as a reducing gas in the production of new DRI pellets.
